(19) United States
(12) Patent Application Publication
(10) Pub. No.: US 2026/0051816 A1
(43) Pub. Date: Feb. 19, 2026

(54) VOLTAGE GENERATION DEVICE AND CHARGE PUMP DEVICE THEREOF

(71) Applicant: Winbond Electronics Corp., Taichung City (TW)

(72) Inventor: Chung-Zen Chen, HsinChu (TW)

(73) Assignee: Winbond Electronics Corp., Taichung City (TW)

(21) Appl. No.: 19/300,600

(22) Filed: Aug. 14, 2025

(30) Foreign Application Priority Data
Aug. 15, 2024 (TW) 113130672

(51) Int. Cl. H02M 3/07

(52) U.S. Cl. CPC H02M 3/07

(57) ABSTRACT

A voltage generation device and a charge pump device are provided. The charge pump device includes a plurality of charge pump units, a control signal generator, and a plurality of capacitors. The charge pump units respectively generate a plurality of pumping voltages based on a base voltage. The control signal generator is configured to generate first to fourth control signals. First ends of the capacitors respectively receive the pumping voltages. A second end of at least one selected capacitor among the capacitors receives the third control signal or the fourth control signal. A second end of an unselected capacitor receives the first control signal or the second control signal. When the charge pump device is in a disabled state, the third control signal and the fourth control signal are maintained at a reference voltage, where the reference voltage is not less than the base voltage.

### CROSS-REFERENCE TO RELATED APPLICATION

This application claims the priority benefit of Taiwan application serial no. 113130672, filed on Aug. 15, 2024. The entirety of the above-mentioned patent application is hereby incorporated by reference herein and made a part of this specification.

### BACKGROUND

### Technical Field

The disclosure relates to a voltage generation device and a charge pump device thereof, and particularly relates to a more sustainable internal voltage generation device and a charge pump device thereof.

### Description of Related Art

In electronic devices, it is usually necessary to dispose an internal voltage generation device to generate an internal voltage. For example, in a flash memory, an internal voltage generation device with a charge pump device is usually disposed to generate a programming voltage higher than an operating voltage.

Conventional internal voltage generation devices include charge pump devices and voltage regulators. The charge pump device includes a plurality of charge pump units and a plurality of capacitors. The capacitors are configured to store the pumping voltage generated by the corresponding charge pump units of each stage, so that a part of the capacitors in the subsequent stage may withstand a larger voltage difference. The voltage regulator is configured to disable the charge pump device when the voltage generated by the charge pump device reaches a target value. Even so, the two ends of a part of the capacitors in the subsequent stage of the charge pump device continue to bear a high voltage difference, causing a part of the capacitors to easily deteriorate and reducing the lifetime of the internal voltage generation device.

### SUMMARY

The disclosure provides a voltage generation device and a charge pump device thereof, which may prevent two ends of a capacitor in a charge pump unit from suffering a high voltage difference.

The charge pump device of the disclosure includes a plurality of charge pump units, a control signal generator, and a plurality of capacitors. The charge pump units are coupled to each other in series, and the charge pump units are configured to respectively generate a plurality of pumping voltages based on a base voltage. The control signal generator is configured to generate first to fourth control signals. First ends of the capacitors respectively receive the pumping voltage. A second end of at least one selected capacitor among the capacitors receives the third control signal or the fourth control signal. A second end of an unselected capacitor among the capacitors receives the first control signal or the second control signal. When the charge pump device is in a disabled state, the third control signal and the fourth control signal are maintained at a reference voltage, where the reference voltage is not less than the base voltage.

A voltage generation device of the disclosure is configured to generate an internal voltage of a memory device. The voltage generation device includes an indication signal generator and the charge pump device as described above. The indication signal generator generates a disable/enable indication signal for indicating whether the charge pump device is in a disabled state according to the internal voltage and a threshold voltage.

Based on the above, the charge pump device of the disclosure uses the control signal generator to provide the reference voltage with a relatively high voltage value to the second end of the selected one or more capacitors when the charge pump device is in the disabled state, thereby reducing the voltage difference between the two ends of the selected capacitor and increasing the lifetime of the voltage generation device.

### BRIEF DESCRIPTION OF THE DRAWINGS

FIG. 1 is a schematic diagram of a charge pump device according to an embodiment of the disclosure.

FIG. 2 and FIG. 3 are schematic diagrams of charge pump devices according to other embodiments of the disclosure.

FIG. 4 is a schematic diagram of an embodiment of a control signal generator in a charge pump device according to an embodiment of the disclosure.

FIG. 5 is a schematic diagram of another embodiment of a control signal generator in a charge pump device according to an embodiment of the disclosure.

FIG. 6 is a schematic diagram of a voltage generation device according to an embodiment of the disclosure.

FIG. 7A is a schematic diagram of a charge pump unit in a charge pump device according to an embodiment of the disclosure.

FIG. 7B is a pumping voltage waveform diagram of a charge pump unit according to an embodiment of the disclosure.

FIG. 8 is a schematic diagram of a voltage generation device according to another embodiment of the disclosure.

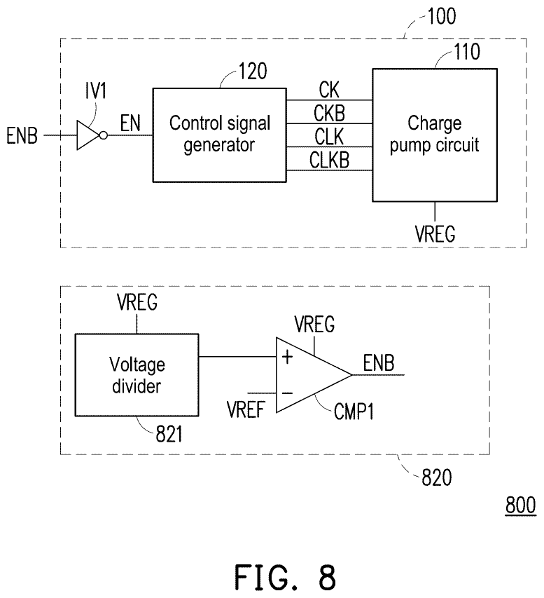

### DESCRIPTION OF THE EMBODIMENTS

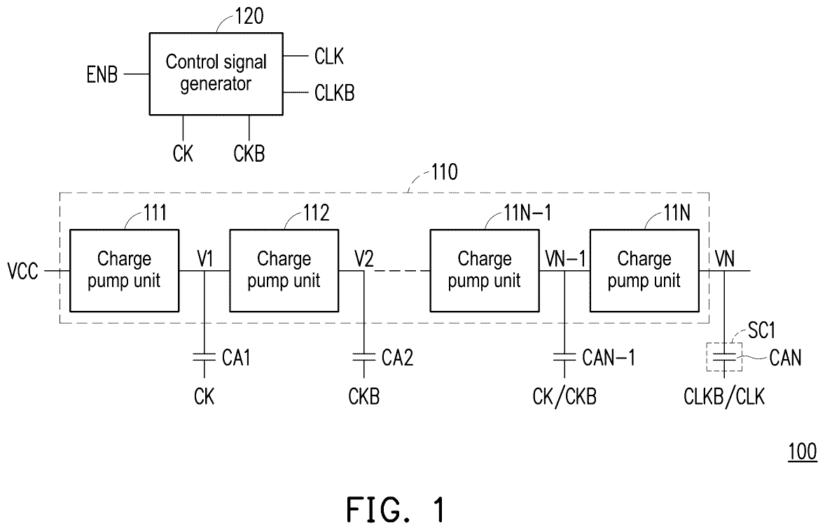

Referring to FIG. 1, a charge pump device 100 includes a charge pump circuit 110 and a control signal generator 120. The charge pump circuit 110 includes a plurality of charge pump units 111 to 11N and a plurality of capacitors CA1 to CAN. The charge pump units 111 to 11N are coupled in series in sequence. The first-stage charge pump unit 111 receives a base voltage VCC and performs a charge pump operation with respect to the base voltage VCC to generate a pumping voltage V1. The second-stage charge pump unit 112 receives the pumping voltage V1 and generates a pumping voltage V2 by increasing the pumping voltage V1. By analogy, the charge pump units 111 to 11N may perform stage-wise charge pump operations to respectively generate sequentially increasing pumping voltages V1 to VN with respect to the base voltage VCC.

The charge pump units 111 to 11N respectively correspond to the capacitors CA1 to CAN. The first ends of the capacitors CA1 to CAN are respectively coupled to the output ends of the charge pump units 111 to 11N to receive the pumping voltages V1 to VN. The second ends of the capacitors CA1 to CAN are coupled to the control signal generator 120. The control signal generator 120 receives a disable/enable indication signal ENB, and determines whether the charge pump device 100 is in a disabled state or an enabled state according to the disable/enable indication signal ENB. The control signal generator 120 generates control signals CK, CKB, CLK, and CLKB correspondingly according to whether the charge pump device 100 is in a disabled state or an enabled state.

It is worth mentioning that at least one of the capacitors CA1 to CAN may be set as the selected capacitor. In the embodiment, the capacitor CAN located at the last stage is set as a selected capacitor SC1. The second end of the selected capacitor SC1 (e.g., the capacitor CAN) may receive the control signal CLK or CLKB (hereafter sometimes also referred to as the selected capacitor control signal), and the second ends of the unselected capacitors SC1 (e.g., the capacitors CA1 to CAN−1) may receive the control signal CK or CKB. In the embodiment, when the charge pump device 100 is in an enabled state, the control signal CK and the control signal CKB may be phase-complementary clock signals, and the control signal CLK and the control signal CLKB may also be phase-complementary clock signals. Moreover, the phases of the control signals CK and CLK may be the same, and the phases of the control signals CKB and CLKB may also be the same.

In addition, in the embodiment, when the charge pump device 100 is in a disabled state, the control signal generator 120 may make the control signals CK and CKB have different logic values respectively, and make the control signals CLK and CLKB have the same reference voltage. The reference voltage may be equal to or higher than the base voltage VCC.

It is worth noting that when the charge pump device 100 is in a disabled state, the embodiment allows the second end of the selected capacitor SC1 to receive the control signals CLK and CLKB having the reference voltage (having a relatively high voltage value). In this way, the cross-voltage between the two ends of the selected capacitor SC1 may be effectively reduced, thereby extending the lifetime of the selected capacitor SC1.

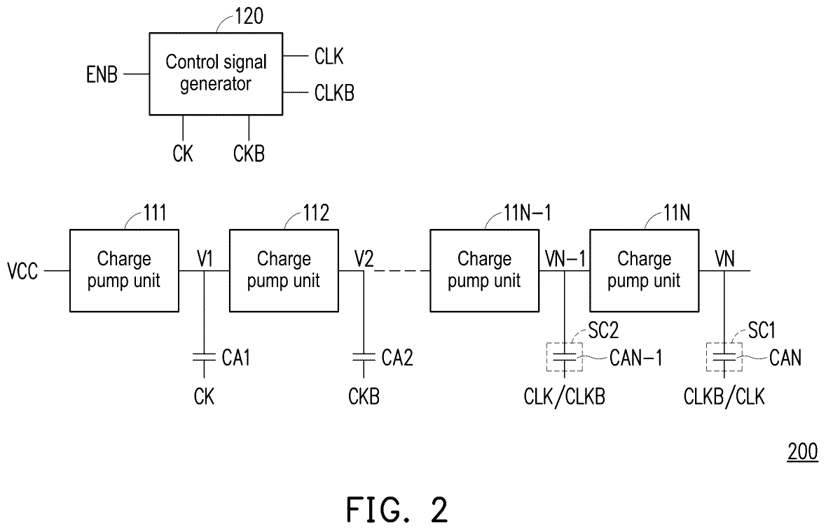

It is worth mentioning that the embodiment of the disclosure does not limit the number of the selected capacitors. As shown in FIG. 2, the capacitors CAN−1 and CAN among the capacitors CA1 to CAN are the selected capacitors SC2 and SC1 respectively. The second end of the capacitor CAN−1 that is the selected capacitor SC2 receives the control signal CLK or CLKB, and the second end of the capacitor CAN that is the selected capacitor SC1 receives the control signal CLKB or CLK. For example, if the second end of the capacitor CAN−1 receives the control signal CLK, the second end of the capacitor CAN may receive the control signal CLKB. Conversely, if the second end of the capacitor CAN−1 receives the control signal CLKB, the second end of the capacitor CAN may receive the control signal CLK.

In the embodiment, when a charge pump device 200 is in a disabled state, the control signals CLK and CLKB received by the second ends of the capacitors CAN−1 and CAN may both be reference voltages with a relatively high voltage value, so that the cross-voltage between the two ends of the capacitors CAN−1 and CAN may be effectively reduced to effectively improve the lifetime thereof.

In addition, the location of the selected capacitor is not limited to the above embodiment. As shown in FIG. 3, the selected capacitor SC1 in a charge pump device 300 may be an intermediate-stage capacitor CAK. In the embodiment of the disclosure, the selected capacitor may be determined according to the materials of the capacitors CA1 to CAN. For example, the unselected capacitors (capacitors CA1 to CAK−1, CAK+1 to CAN) may include transistors with high voltage resistance or metal-insulating material (such as silicon oxide-silicon carbide-silicon oxide, ONO)-metal capacitors. The selected capacitor (capacitor CAK) may include a transistor with low voltage resistance. In order to ensure that each capacitor CA1 to CAN has a lifetime of at least 10 years or more, the designer may configure any one or more of the capacitors CA1 to CAN that cannot withstand high voltage differences as the selected capacitors.

In the embodiment, the first end of the capacitor CAK serving as the selected capacitor SC1 receives a pumping voltage VK generated by the charge pump unit 11K, and the second end of the capacitor CAK receives the control signal CLKB or CLK. When the charge pump device 300 is in a disabled state, the control signal generator 120 may make the control signals CLK and CLKB have the same reference voltage, thereby reducing the cross-voltage between the two ends of the capacitor CAK to increase the lifetime of the capacitor CAK. Of course, in the embodiment, the number of the selected capacitors may also be plural. The illustration in FIG. 3 is only an example for illustration and is not intended to limit the scope of the disclosure.

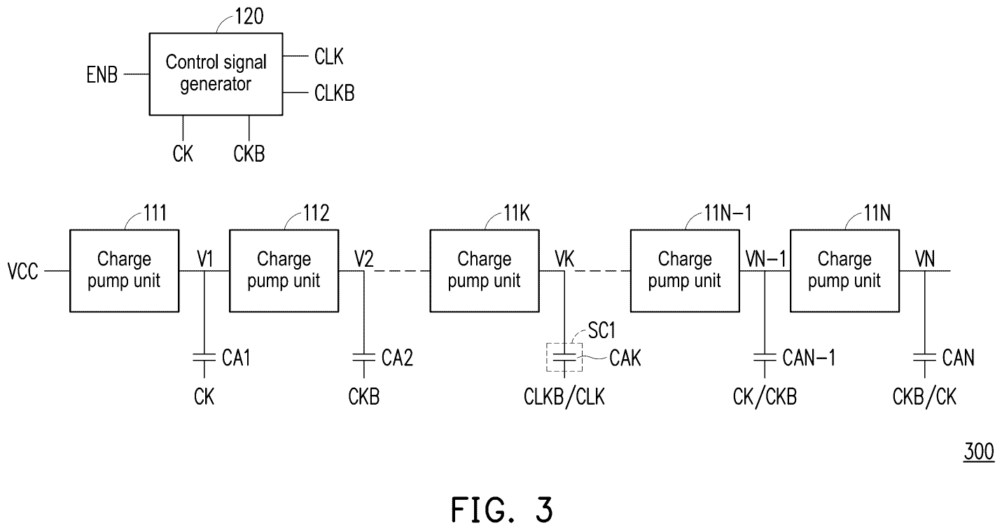

In an embodiment, as shown in FIG. 4, a control signal generator 120A may include an oscillator 410 and a logic circuit 420. An inverter IV1 receives and inverts the disable/enable indication signal ENB, and outputs an oscillator control signal EN.

The oscillator 410 is coupled to the output end of the inverter IV1 and determines whether to be enabled according to the oscillator control signal EN. When the disable/enable indication signal ENB is logic value 0, it indicates that the corresponding charge pump device is in an enabled state. At this time, the oscillator 410 may be enabled according to the oscillator control signal EN with logic value 1, and generate the control signals CK and CKB which are periodic clock signals. In contrast, when the disable/enable indication signal ENB is logic value 1, it indicates that the corresponding charge pump device is in a disabled state. At this time, the oscillator 410 may stop the oscillation operation of the control signals CK and CKB according to the oscillator control signal EN with logic value 0. At the same time, the control signals CK and CKB may be respectively maintained at different logic values.

On the other hand, the logic circuit 420 may perform a logical operation on the control signals CK and CKB and the disable/enable indication signal ENB respectively, so as to generate the selected capacitor control signals CLK and CLKB respectively. In the embodiment, the logic circuit 420 includes NOR-gates NO1 and NO2 and inverters IV2 and IV3. The input end of the NOR-gate NO1 receives the control signal CK and the disable/enable indication signal ENB, and the output end of the NOR-gate NO1 is coupled to the input end of the inverter IV2. The input end of the NOR-gate NO2 receives the control signal CKB and the disable/enable indication signal ENB, and the output end of the NOR-gate NO2 is coupled to the input end of the inverter IV3. The output ends of the inverters IV2 and IV3 respectively generate the selected capacitor control signals CLK and CLKB.

When the charge pump device is in an enabled state, the disable/enable indication signal ENB is logic value 0. The NOR-gate NO1 may output the inverted signal of the control signal CK to the inverter IV2. The inverter IV2 correspondingly generates the selected capacitor control signal CLK with the same phase as the control signal CK. In addition, the NOR-gate NO2 may output the inverted signal of the control signal CKB to the inverter IV3. The inverter IV3 correspondingly generates the selected capacitor control signal CLKB with the same phase as the control signal CKB.

In contrast, when the charge pump device is in a disabled state, the disable/enable indication signal ENB is logic value 1. The NOR-gates NO1 and NO2 may both output logic value 0 to the inverters IV2 and IV3. The inverters IV2 and IV3 correspondingly generate the selected capacitor control signals CLK and CLKB that maintain logic value 1. In the embodiment, the inverters IV2 and IV3 may receive the base voltage of the charge pump device (such as the base voltage VCC) as the operating voltage. Therefore, the levels of the control signals CLK and CLKB may be maintained equal to the base voltage.

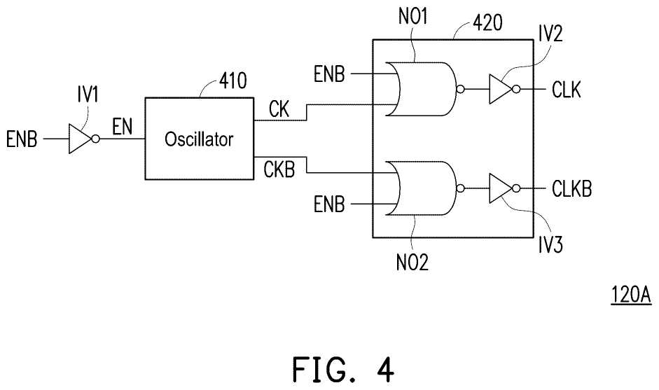

In another embodiment, as shown in FIG. 5, a control signal generator 120B may include the oscillator 410 and a logic circuit 520. Different from FIG. 4, inverters LS1 and LS2 may be implemented by level shifters. The inverters LS1 and LS2 may receive a voltage Vj as the operating voltage. When the charge pump device is in a disabled state, the inverters LS1 and LS2 may generate the selected capacitor control signals CLK and CLKB with logic value 1. Based on the operating voltage of the inverters LS1 and LS2 being the voltage Vj, the inverters LS1 and LS may make the levels of the selected capacitor control signals CLK and CLKB equal to the voltage Vj.

In the embodiment, the voltage Vj may be the pumping voltage generated by any one of the fore-stage charge pump units 111 to 11j before the charge pump unit 11j+1 coupled to the selected capacitor, where j+1 is less than or equal to N. Therefore, the voltage Vj may be greater than or equal to the aforementioned base voltage VCC, and less than the pumping voltage generated by the charge pump unit coupled to the selected capacitor.

In other embodiments, the voltage Vj may also not be provided by the pumping voltage generated by any one of the fore-stage charge pump units 111 to 11j before the charge pump unit 11j+1 coupled to the selected capacitor 11j+1, but may be provided by an external voltage or other charge pump device, and the disclosure is not limited thereto.

In the embodiment, when the charge pump device is in a disabled state, the control signal generator 120B provides the selected capacitor control signals CLK and CLKB with the voltage Vj to the second end of the selected capacitor, thereby effectively reducing the cross-voltage between the two ends of the selected capacitor, thereby improving the lifetime of the selected capacitor.

In FIG. 4 and FIG. 5, the oscillator 410 may be a ring oscillator, or other oscillators well known to those skilled in the art, and the disclosure is not limited thereto.

A voltage generation device 600 according to an embodiment of the disclosure may be configured to generate an internal voltage of an electronic device, for example, to generate a programming voltage of a memory device, but the disclosure is not limited thereto. The voltage generation device 600 may include the charge pump device 100 as shown in FIG. 1 and a voltage regulator 620. The charge pump device 100 includes the aforementioned control signal generator 120 and charge pump circuit 110. The charge pump circuit 110 generates a plurality of pumping voltages according to the control signals CK and CKB received from the control signal generator 120 and the selected capacitor control signals CLK and CLKB, and may provide the highest of the pumping voltages to generate a supply voltage VPP. Details of the charge pump device 100 have been mentioned in the previous embodiments and will not be repeated.

The voltage regulator 620 includes a transistor M1, a voltage divider 621, and a comparator CMP1. The voltage divider 621 and the comparator CMP1 constitute an indication signal generator. The first end of the transistor M1 receives the supply voltage VPP; the control end of the transistor M1 receives the disable/enable indication signal ENB; and the second end of the transistor M1 is configured to generate an internal voltage VREG (e.g., programming voltage). The voltage divider 621 is configured to divide the programming voltage VREG and provide the generated divided voltage to the positive input end of the comparator CMP1. The negative input end of the comparator CMP1 receives a threshold voltage VREF. The comparator CMP1 is configured to compare the divided voltage (i.e., the output of the voltage divider 621) with the threshold voltage VREF, and generate the disable/enable indication signal ENB according to the comparison result.

In detail, when the divided voltage generated by the voltage divider 621 is greater than or equal to the threshold voltage VREF, the comparator CMP1 may generate a disable/enable indication signal ENB with logic value 1, so that the transistor M1 is turned off and the charge pump device 100 is disabled. When the divided voltage generated by the voltage divider 621 is less than the threshold voltage VREF, the comparator CMP1 may generate the disable/enable indication signal ENB with logic value 0, so that the transistor M1 is turned on and the charge pump device 100 is enabled. Incidentally, the comparator CMP1 may receive the supply voltage VPP as the operating voltage.

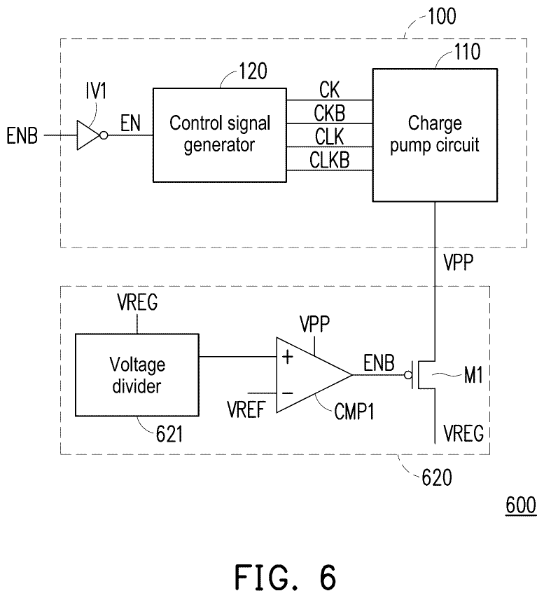

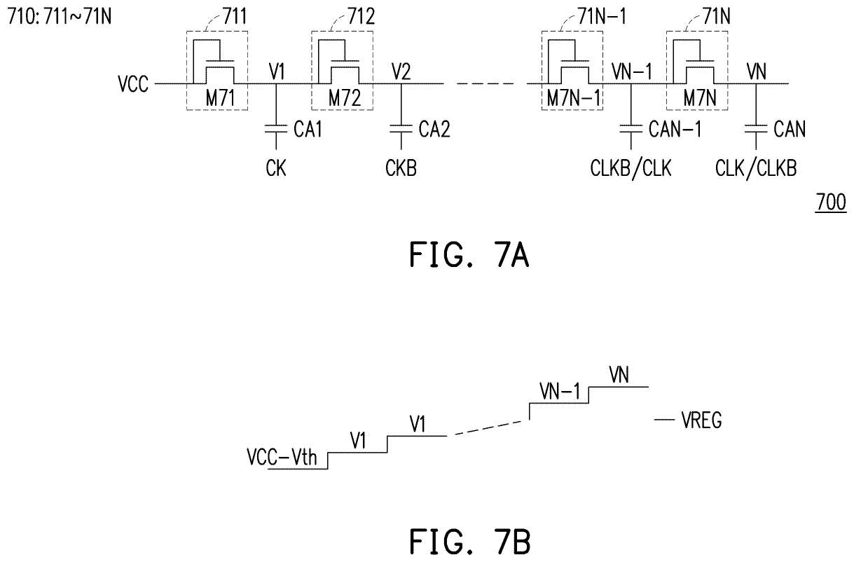

For details of the charge pump unit according to the embodiment of the disclosure, please refer to FIG. 7A, which is a schematic diagram of a charge pump unit in a charge pump device according to an embodiment of the disclosure, and FIG. 7B, which is a pumping voltage waveform diagram of a charge pump unit according to an embodiment of the disclosure. In a charge pump device 700 of FIG. 7A, a charge pump circuit 710 has a plurality of charge pump units 711 to 71N coupled in series. The charge pump units 711 to 71N are respectively composed of a plurality of transistors M71 to M7N. Each transistor M71 to M7N may be coupled into a diode configuration. The output ends of the charge pump units 711 to 71N are respectively coupled to the capacitors CA1 to CAN. The first-stage charge pump unit 711 receives the base voltage VCC, and the charge pump units 711 to 71N respectively generate the pumping voltages V1 to VN.

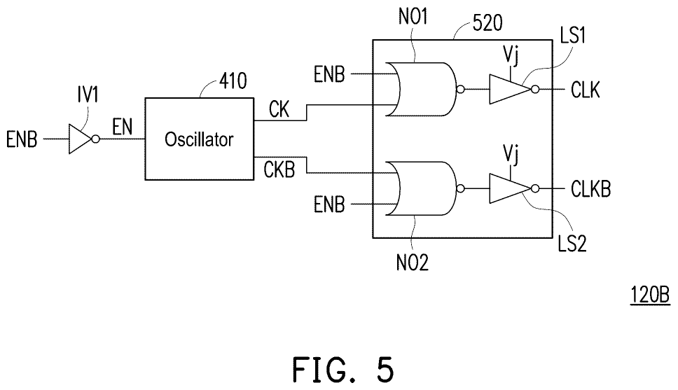

In FIG. 7B, the first-stage charge pump unit 711 may generate the pumping voltage V1 by multiplying the difference between the base voltage VCC and a turn-on voltage Vth by two times, where the threshold voltage Vth is the turn-on voltage of the transistor M71. The pumping voltage V2 generated by the second-stage charge pump unit 711 may be twice the pumping voltage V1. By analogy, the charge pump units 711 to 71N may sequentially generate stage-wise increasing pumping voltages V1 to VN. Corresponding to the embodiment of FIG. 6, the pumping voltage VN of the last-stage charge pump unit 71N may be equal to or greater than the required internal voltage VREG.

In another embodiment of the disclosure, a voltage generation device 800 may include the charge pump device 100 as shown in FIG. 1 and an indication signal generator 820. The charge pump circuit 110 generates a plurality of pumping voltages according to the control signals CK and CKB received from the control signal generator 120 and the selected capacitor control signals CLK and CLKB, and may provide the highest of the pumping voltages to generate the internal voltage VREG. Details of the charge pump device 100 have been mentioned in the previous embodiments and will not be repeated.

The indication signal generator 820 includes a voltage divider 821 and the comparator CMP1. The voltage divider 821 divides the internal voltage VREG and provides the generated divided voltage to the positive input end of the comparator CMP1. The negative input end of comparator CMP1 receives the threshold voltage VREF. The comparator CMP1 is configured to compare the divided voltage with the threshold voltage VREF, and generate the disable/enable indication signal ENB according to the comparison result. Incidentally, the comparator CMP1 may receive the internal voltage VREG as the operating voltage.

To sum up, the charge pump device of the disclosure selects one or more capacitors as the selected capacitor, and makes the second end of the selected capacitor to receive a reference voltage higher than or equal to the base voltage when the charge pump device is in a disabled state. In this way, when the charge pump device is in a disabled state, the two ends of the selected capacitor do not continue to bear an excessive voltage difference, which may cause accelerated deterioration. Furthermore, in the charge pump device, the lifetime of the capacitor may be effectively improved and meet the requirements of green semiconductors.

What is claimed is:

1. A charge pump device, comprising:
a plurality of charge pump units, wherein the charge pump units are coupled to each other in series, and the charge pump units are configured to respectively generate a plurality of pumping voltages based on a base voltage;
a control signal generator, configured to generate a first control signal, a second control signal, a third control signal, and a fourth control signal; and
a plurality of capacitors, wherein first ends of the capacitors respectively receive the pumping voltages, a second end of at least one selected capacitor among the capacitors receives the third control signal or the fourth control signal, and a second end of an unselected capacitor among the capacitors receives the first control signal or the second control signal,
wherein when the charge pump device is in a disabled state, the third control signal and the fourth control signal are maintained at a reference voltage, and the reference voltage is not less than the base voltage.

2. The charge pump device according to claim 1, wherein when the charge pump device is in an enabled state, the third control signal and the fourth control signal are phase-complementary clock signals, and the first control signal and the second control signal are phase-complementary clock signals.

3. The charge pump device according to claim 1, wherein the control signal generator comprises:
an oscillator, configured to generate the first control signal and the second control signal and determine whether to stop an oscillation operation of the first control signal and the second control signal according to a disable/enable indication signal; and
a logic circuit, coupled to the oscillator, and configured to respectively generate the third control signal and the fourth control signal according to the first control signal and the second control signal, and determine whether to maintain the third control signal and the fourth control signal at the reference voltage according to the disable/enable indication signal.

4. The charge pump device according to claim 3, wherein the logic circuit receives the reference voltage as an operating voltage, and when the disable/enable indication signal indicates that the charge pump device is in the disabled state, the third control signal and the fourth control signal are maintained at the reference voltage.

5. The charge pump device according to claim 3, wherein when the charge pump device is in the disabled state, the oscillator determines to stop the oscillation operation of the first control signal and the second control signal according to the disable/enable indication signal.

6. The charge pump device according to claim 3, wherein the logic circuit is configured to perform a logical operation on the first control signal and the second control signal and the disable/enable indication signal to respectively generate the third control signal and the fourth control signal.

7. The charge pump device according to claim 3, wherein the logic circuit comprises:
a first NOR-gate, configured to receive the first control signal and the disable/enable indication signal and generate a first signal;
a second NOR-gate, configured to receive the second control signal and the disable/enable indication signal and generate a second signal;
a first inverter, configured to receive the first signal and generate the third control signal; and
a second inverter, configured to receive the second signal and generate the fourth control signal.

8. The charge pump device according to claim 7, wherein the first inverter and the second inverter are level shifters, and an operating voltage of the first inverter and the second inverter is equal to the pumping voltage generated by any one of the charge pump units located before the selected capacitor.

9. A voltage generation device, configured to generate an internal voltage of a memory device, comprising:
an indication signal generator, configured to generate a disable/enable indication signal based on the internal voltage and a threshold voltage; and
a charge pump device, coupled to the indication signal generator, wherein the charge pump device comprises:
a plurality of charge pump units, wherein the charge pump units are coupled to each other in series, and the charge pump units are configured to respectively generate a plurality of pumping voltages based on a base voltage;
a control signal generator, configured to generate a first control signal, a second control signal, a third control signal, and a fourth control signal; and
a plurality of capacitors, wherein first ends of the capacitors respectively receive the pumping voltages, a second end of at least one selected capacitor among the capacitors receives the third control signal or the fourth control signal, and a second end of an unselected capacitor among the capacitors receives the first control signal or the second control signal,
wherein when the charge pump device is in a disabled state, the third control signal and the fourth control signal are maintained at a reference voltage, and the reference voltage is not less than the base voltage.

10. The voltage generation device according to claim 9, wherein a highest of the pumping voltages is the internal voltage, the indication signal generator is configured to divide the internal voltage to obtain a divided voltage and compare the divided voltage with the threshold voltage to generate the disable/enable indication signal.

11. The voltage generation device according to claim 9, further comprising:
a voltage regulator, comprising:
the indication signal generator and a transistor,
wherein a first end of the transistor receives a highest of the pumping voltages, a control end of the transistor receives the disable/enable indication signal, and a second end of the transistor provides the internal voltage.

12. The voltage generation device according to claim 9, wherein when the charge pump device is in an enabled state, the third control signal and the fourth control signal are phase-complementary clock signals, and the first control signal and the second control signal are phase-complementary clock signals.

13. The voltage generation device according to claim 9, wherein the control signal generator comprises:
an oscillator, configured to generate the first control signal and the second control signal and determine whether to stop an oscillation operation of the first control signal and the second control signal according to the disable/enable indication signal; and
a logic circuit, coupled to the oscillator, and configured to respectively generate the third control signal and the fourth control signal according to the first control signal and the second control signal, and determine whether to maintain the third control signal and the fourth control signal at the reference voltage according to the disable/enable indication signal.

14. The voltage generation device according to claim 13, wherein the logic circuit receives the reference voltage as an operating voltage, and when the disable/enable indication signal indicates that the charge pump device is in the disabled state, the third control signal and the fourth control signal are maintained at the reference voltage.

15. The voltage generation device according to claim 13, wherein the logic circuit is configured to perform a logical operation on the first control signal and the second control signal and the disable/enable indication signal to respectively generate the third control signal and the fourth control signal.

16. The voltage generation device according to claim 13, wherein the logic circuit comprises:
a first NOR-gate, configured to receive the first control signal and the disable/enable indication signal and generate a first signal;
a second NOR-gate, configured to receive the second control signal and the disable/enable indication signal and generate a second signal;
a first inverter, configured to receive the first signal and generate the third control signal; and
a second inverter, configured to receive the second signal and generate the fourth control signal.

17. The voltage generation device according to claim 16, wherein the first inverter and the second inverter are level shifters, and an operating voltage of the first inverter and the second inverter is equal to the pumping voltage generated by any one of the charge pump units located before the selected capacitor.
